(19) United States
(12) Patent Application Publication
(10) Pub. No.: US 2011/0242508 A1
(43) Pub. Date: Oct. 6, 2011

(54) INTERFACE SYSTEM

(75) Inventor: Shinji Kobayashi, Yamanashi-ken (JP)

(73) Assignee: TOKYO ELECTRON, LIMITED, MINATO-KU (JP)

(21) Appl. No.: 13/123,311

(22) PCT Filed: Sep. 29, 2009
(86) PCT No.: PCT/JP2009/066898

§ 371 Date: Apr. 8, 2011

(30) Foreign Application Priority Data
Nov. 19, 2008 (JP) 2008-295642

(51) Int. Cl. G03B 27/32

(52) U.S. Cl. 355/27; 355/77

(57) ABSTRACT

An interface system includes: a first transfer chamber having a closable first transfer opening through which a substrate is transferred between the first transfer chamber and an exposure system and capable of being evacuated to a reduced pressure; a plurality of load-lock chambers each having a second transfer opening through which a substrate is transferred between the load-lock chamber and the first transfer chamber, and a third transfer opening through which a substrate is transferred between the load-lock chamber and the coating and developing system; a plurality of heating modules for heating a substrate, each having a fifth transfer opening through which a substrate is transferred between the same heating module; and a plurality of cooling modules for cooling a substrate, each having a sixth transfer opening through which a substrate is transferred between the same cooling module and the second transfer chamber.

### TECHNICAL FIELD

The present disclosure relates to an interface system disposed between an exposure system for processing a resist film by an exposure process using extreme ultraviolet light and a coating and developing system for forming a resist film on a substrate and processing the resist film processed by the exposure process by the exposure system by a developing process, a substrate carrying method, and a computer-readable recording medium.

### BACKGROUND ART

Further miniaturization of semiconductor devices requires the realization of thin lines of a width on the order of about 20 nm. An exposure system using extreme ultraviolet light (hereinafter, abbreviated to “EUV light”) is under development to realize such thin lines of a very small width. An EUV exposure system exposes a resist film to EUV light in a vacuum because EUV light cannot propagate through the atmosphere. A coating process for coating a wafer with a resist film and a developing process for processing the wafer processed by the exposure process are carried out in the atmosphere. Therefore, a load-lock mechanism is indispensable as an interface system between the coating and developing system and the EUV exposure system.

### Prior Art Technical Document

Patent document 1: JP 2008-34739 A

### DISCLOSURE OF THE INVENTION

### Problem to be Solved by the Invention

The inventors of the present disclosure found through studies that a problem in the EUV exposure system is not only the contamination of its optical system with gases evaporated from a resist film, such as a solvent gas, but also the solidification (graphitization) of organic substances contained in a cleanroom atmosphere flowed into the EUV exposure system by EUV light and the deposition of the solidified substances on the components of the optical system, such as mirrors. Most organic substances contained in a cleanroom atmosphere have a high carbon number. Such organic substances solidified on the components of the optical system are difficult to remove and the expensive optical system needs to be replaced with another one.

When a wafer is transferred from a coating and developing system through a load-lock chamber to an exposure system, the effect of such a problem can be reduced to some extent by repeating a procedure including the steps of evacuating the load-lock chamber, filling up the load-lock chamber with, for example, nitrogen gas (N₂), and evacuating the load-lock chamber again.

When the procedure is repeated again and again, it takes long time to carry the wafer. Since an EUV exposure process is carried out in a high vacuum of a pressure in the range of, for example, 10⁻⁵ to 10⁻⁶ Pa, the load-lock chamber needs to be evacuated to such a high vacuum after the procedure. An operation for evacuating the load-lock chamber in such a high vacuum takes still longer time.

From the viewpoint of the repeatability of the process, it is preferable that time between the start of a coating process of coating a wafer with a resist film to the completion of an exposure process, and time from the completion of the exposure process to the completion of a developing process are substantially constant for wafers. Therefore, it is preferable to carry wafers between the coating and developing system and the exposure system in a single-wafer carrying mode and not in a batch carrying mode.

When wafers are carried in a single-wafer carrying mode, the foregoing procedure needs to be repeated again and again and the load-lock chamber needs to be evacuated in a high vacuum for each wafer. Under such a process condition, it is scarcely possible to achieve both a high throughput of, for example, 100 wafers per hour and the reduction of contamination.

The present disclosure has been made in view of the foregoing problems and it is therefore an object of the present disclosure to provide an interface system capable of reducing the contamination of an EUV exposure system and of improving throughput and suitable for installation between a coating and developing system and an EUV exposure system, a substrate carrying method, and a computer-readable storage medium.

### Means for Solving the Problem

An interface system in a first mode of the invention to be installed between an exposure system using EUV light for exposing a resist film, and a coating and developing system for forming a resist film on a substrate and developing the resist film exposed by the exposure system includes: a first transfer chamber having a closable first transfer opening through which a substrate is transferred between the first transfer chamber and the exposure system and capable of being evacuated to a reduced pressure; a plurality of load-lock chambers capable of being evacuated to a reduced pressure and each having a closable second transfer opening through which a substrate is transferred between the load-lock chamber and the first transfer chamber, and a closable third transfer opening through which a substrate is transferred between the load-lock chamber and the coating and developing system; a second transfer chamber having a closable fourth transfer opening through which a substrate is transferred between the second transfer chamber and the first transfer chamber, and capable of being evacuated at a reduced pressure; a plurality of heating modules for heating a substrate under a reduced pressure each having a closable fifth transfer opening by means of which the heating module communicates with the second transfer chamber to transfer a substrate; and a plurality of cooling modules for cooling a substrate under a reduced pressure each having a sixth transfer opening by means of which the cooling module communicates with the second transfer chamber to transfer a substrate.

An interface system in a second mode of the invention to be installed between an exposure system using EUV light for exposing a resist film, and a coating and developing system for forming a resist film on a substrate and developing the resist film exposed by the exposure system includes: a first transfer chamber having a closable first transfer opening through which a substrate is transferred between the first transfer chamber and the exposure system and capable of being depressurized; and a plurality of load-lock chambers capable of being depressurized and each having a closable second transfer opening through which a substrate is transferred between the load-lock chamber and the first transfer chamber and a closable third transfer opening through which a substrate is transferred between the load-lock chamber and the coating and developing system.

In an interface system in a third mode of the present disclosure according to the first or the second mode of the present disclosure, each of the plurality of load-lock chambers is provided with a gas jetting unit for jetting a gas onto a substrate being carried into or being carried out of the load-lock chamber, disposed near either or both of the second and the third transfer opening.

In an interface system in a fourth mode of the present disclosure according to any one of the first to the third mode of the present disclosure, each of the plurality of load-lock chambers is provided with a gas supply unit for supplying a gas into the load-lock chamber.

In an interface system in a fourth mode of the present disclosure according to any one of the first to the third mode of the present disclosure, each of the plurality of load-lock chambers is provided with a gas supply unit for supplying a gas into the load-lock chamber.

In an interface system in a fifth mode of the present disclosure according to the fourth mode of the present disclosure, the gas supply unit is disposed so as to produce a gas flow flowing toward the third transfer opening when the third transfer opening is open.

In an interface system in a sixth mode of the present disclosure according to any one of the first to the fifth mode of the present disclosure, the plurality load-lock chambers are stacked up in layers.

In an interface system in a seventh mode of the present disclosure according to any one of the first to the sixth mode of the present disclosure, the first transfer chamber is provided with a substrate carrying unit for carrying a substrate into and carrying a wafer out of the plurality of load-lock chambers.

In an interface system in an eighth mode of the present disclosure according to any one of the first to the seventh mode of the present disclosure, the plurality of load-lock chambers are individually provided with a vacuum pump.

In an interface system in a ninth mode of the present disclosure according to the first mode of the present disclosure, the plurality of heating modules are stacked up in layers,

In an interface system in a tenth mode of the present disclosure according to the first or the ninth mode of the present disclosure, the plurality of cooling modules are stacked up in layers.

In an interface system in an eleventh mode of the present disclosure according to any one of the first, ninth and the tenth mode of the present disclosure, the first transfer chamber is provided with a substrate carrying unit for carrying a substrate to and carrying out a substrate from the plurality of load-lock chambers, the plurality of heating modules and the plurality of cooling modules.

In an interface system in a twelfth mode of the present disclosure according to any one of the first and the ninth to the tenth mode of the present disclosure, both or either of the plurality of heating modules and the plurality of cooling modules are provided with a stage provided with an electrostatic chuck, for supporting a substrate thereon.

In an interface system in a thirteenth mode of the present disclosure according to any one of the first and the ninth to the twelfth mode of the present disclosure, both or either of the fifth and the sixth transfer opening is provided with a closable door.

A substrate carrying method in a fourteenth mode of the present disclosure carries a substrate from a coating and developing system through the interface system in the first mode of the present disclosure to an exposure system. The substrate carrying method includes the steps of: carrying a substrate coated with a resist film from the coating and developing system to one of the plurality of load-lock chambers of the interface system under atmospheric pressure; evacuating the same load-lock chambers in a first vacuum; carrying the substrate from the same load-lock chamber to the first transfer chamber in the first vacuum; carrying the substrate from the first transfer chamber through the second transfer chamber to one of the plurality of heating modules in the first vacuum; heating the substrate in the first vacuum by the same heating module; carrying the substrate in the first vacuum from the same heating module to one of the plurality of cooling modules; cooling the substrate in the first vacuum by the same cooling module; carrying the substrate in the first vacuum from the cooling module through the second transfer chamber to the first transfer chamber; evacuating the first transfer chamber in a second vacuum lower than the first vacuum; and carrying the substrate in the second vacuum from the first transfer chamber to the exposure system.

In the substrate carrying method in a fifteenth mode of the present disclosure according to the fourteenth mode, the first vacuum is in the range of 10⁻⁴ to 10⁻⁵ Pa and the second vacuum is in the range of 10⁻² to 10⁻⁴ Pa

A substrate carrying method in a sixteenth mode of the present disclosure for carrying a substrate from a coating and developing system through the interface, system in the second mode of the present disclosure to an exposure system includes the steps of: carrying a substrate coated with a resist film from the coating and developing system to one of the plurality of load-lock chambers of the interface system under atmospheric pressure; evacuating one of the load-lock chambers at a reduced pressure; carrying the substrate from the load-lock chamber to the first transfer chamber under the reduced pressure; and carrying the substrate from the first transfer chamber to the exposure system under the reduced pressure.

The substrate carrying method in a seventeenth mode of the present disclosure for carrying a substrate from an exposure system through the interface system in the first or the second mode of the present disclosure to a coating and developing system includes the steps of: carrying a substrate processed by an exposure process from the exposure system to the first transfer chamber under a reduced pressure; carrying the substrate under a reduced pressure from the first transfer chamber to one of the plurality of load-lock chambers; relieving the vacuum in the same load-lock chamber to set the interior of the same load-lock chamber at atmospheric pressure; and carrying the substrate from the same load-lock chamber to the coating and developing system.

In a substrate carrying method in an eighteenth mode of the present disclosure according to the fourteenth or the sixteenth mode of the present disclosure, each of the plurality of load-lock chambers is provided with a gas jetting unit for jetting a gas onto a substrate carried into the load-lock chamber, adjoining to either or both of the second and the third transfer opening.

In a substrate carrying method in a nineteenth mode of the present disclosure according to any one of the fourteenth, the sixteenth and the eighteenth mode of the present disclosure, each of the plurality of load-lock chambers is provided with a gas supply unit for supplying a gas into the load-lock chamber, and the gas flows from the gas supply unit through the third transfer opening into the load-lock chamber in the step of carrying the substrate into the load-lock chamber.

A computer-readable storage medium in a twentieth mode of the present disclosure stores a computer program specifying the substrate carrying method in any one of the fourteenth to the nineteenth mode of the present disclosure to be carried out by the interface system in any one of the first to the thirteenth mode of the present disclosure.

The present disclosure provides the interface system interposed between the coating and developing system and the EUV exposure system capable of reducing the contamination of the EUV exposure system and of improving throughput, the substrate carrying method and the computer-readable storage medium.

### BRIEF DESCRIPTION OF THE DRAWINGS

FIG. 1 is a schematic perspective view of an interface system in a first embodiment according to the present disclosure, and a coating and developing system and an EUV exposure system suitable for combination with the interface system;

FIG. 2 is a schematic plan view of the interface system, the coating and developing system and the EUV exposure system;

FIG. 3 is a schematic perspective view of the interface system in the first embodiment of the present disclosure;

FIGS. 4(A) and 4(B) are a schematic sectional view and a schematic plan view, respectively, of a load-lock chamber included in the interface system shown in FIG. 3;

FIG. 5 is a plan view of assistance in explaining the positional relation between the interface system in the first embodiment of the present disclosure, and the coating and developing system and the EUV exposure system suitable for combination with the interface system;

FIGS. 6(A) and 6(B) are time charts of assistance in explaining a wafer carrying operation to be carried out by the interface system in the first embodiment of the present disclosure;

FIG. 7 is a schematic perspective view of a vacuum processing system in a second embodiment according to the present disclosure;

FIGS. 8(A) and 8(B) are a schematic sectional view and a schematic plan view, respectively, of a heating module included in the vacuum processing system shown in FIG. 7;

FIGS. 9(A) and 9(B) are a schematic sectional view and a schematic plan view, respectively, of a cooling module included in the vacuum processing system shown in FIG. 7; and

FIG. 10 is a typical perspective view of an interface system in a modification of the embodiment of the present disclosure.

### BEST MODE FOR CARRYING OUT THE INVENTION

An interface system in a preferred embodiment according to the present disclosure will be described with reference to the accompanying drawings, in which the same or corresponding members or parts are designated by the same reference characters and the duplicate description thereof will be omitted. The drawings are not intended to show the relative dimensions of parts. Concrete dimensions shall be determined by persons skilled in the art with reference to the following not limitative embodiments.

An interface system in a first embodiment according to the present disclosure is interposed between a resist film forming and developing system (hereinafter referred to simply as “coating and developing system”) for forming a resist film on a wafer W and developing the resist film processed by an exposure process and an EUV exposure system for processing the resist film formed by the coating and developing system by an EUV exposure process.

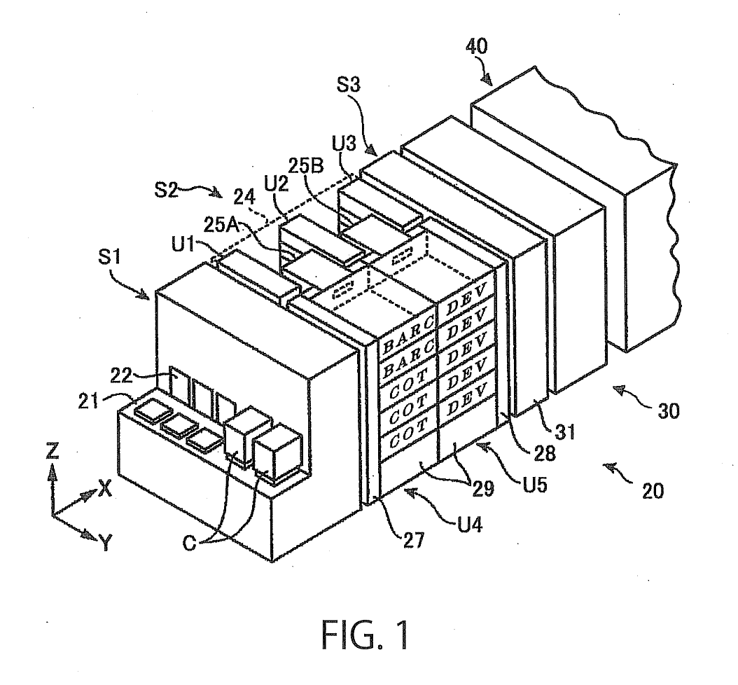

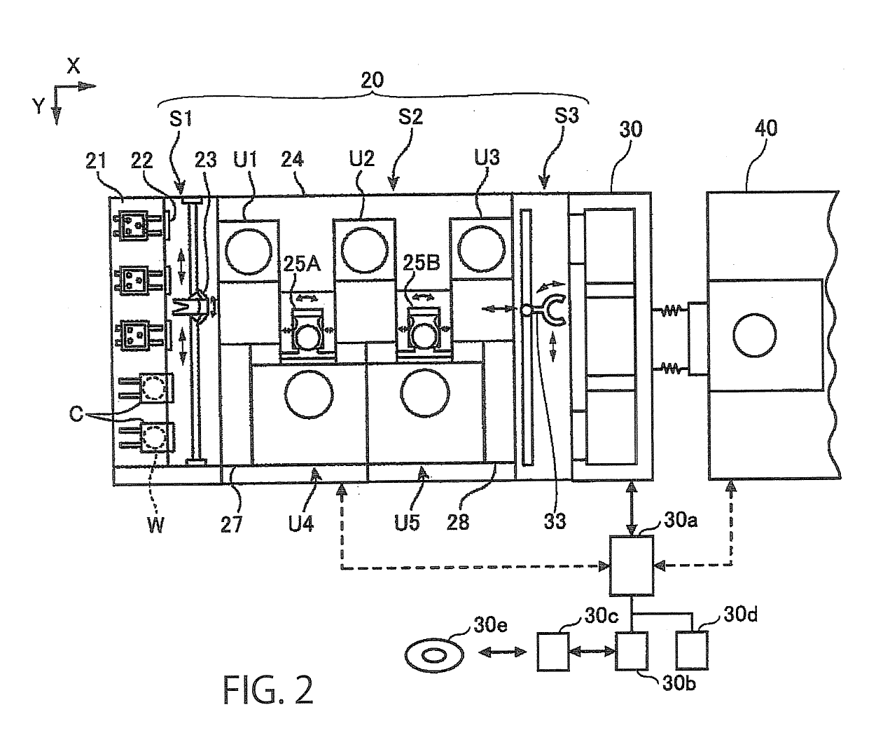

First, the coating and developing system connected to the interface system in the first embodiment will be described with reference to FIGS. 1 and 2. Referring to FIG. 1, the coating and developing system 20 has a cassette station Si to which a wafer cassette C, such as the so-called FOUP (front opening universal pod), containing wafers W is delivered and from which the wafer cassette C is sent out. The cassette station S1 is provided with a table 21 capable of supporting a plurality of wafer cassettes C thereon, a plurality of closable openings 22 respectively corresponding to wafer cassettes C placed on the table 21 and a carrying mechanism 23 (FIG. 2) for taking out a wafer W through the closable opening 22 from the wafer cassette C and returning the wafer W into the wafer cassette C. The wafer cassette C can hold a plurality of wafers W, for example thirteen wafers W.

The coating and developing system 20 has a processing block S2 surrounded by a box 24 and adjacent to the cassette station S1. As shown in FIG. 2, the processing block S2 has a shelf unit U1, a main carrying unit 25A, a shelf unit U2, a main carrying unit 25B and a shelf unit U3 arranged in that order in an X-direction.

Each of the shelf units U1, U2 and U3 has heating units and/or cooling units stacked up in layers to accomplish a pretreatment process and a posttreatment process to be accomplished before and after, respectively, wet processes to be carried out by wet-processing units U4 and U5, which will be described later.

The main carrying units 25A and 25B carry a wafer W to and from the shelf units U1, U2 and U3, and processing units including the coating and developing units U4 and U5. Each of the shelf units U1, U2 and U3 and the main carrying units 25A and 25B is provided with an opening, not shown. A wafer W can be carried through the openings from the shelf unit U1 to the shelf unit U3.

The carrying unit 25A is surrounded by the shelf unit U1, the wet-processing unit U4 and the shelf unit U2. Similarly, the carrying unit 25B is surrounded by the shelf unit U2, the wet-processing unit U5 and the shelf unit U3.

As shown in FIG. 1, the wet-processing units U4 and U5 have solution containers 29 containing a resist solution and a developer, a plurality of units including coating units COT, antireflection film forming units BARC and developing units DEV stacked up in a plurality of layers, such as five layers, on the solution containers 29. The wet-processing unit U4 has the three coating units COT and two antireflection film forming units BARC stacked up in three and two layers, respectively. The wet-processing unit U5 has five developing units DEV stacked up in five layers. The combination of the coating units COT, the developing units DEV and the antireflection film forming units BARC is not limited to that shown in. FIG. 1 and may be combined in any proper combination. A hygrothermal regulating unit 27 (28) is adjacent to the wet-processing unit U4 (U5). Each of the hygrothermal regulating units 27 and 28 includes a temperature regulating device for regulating the temperature of solutions to be used by the wet-processing unit and ducts for air conditioning.

A carrying unit S3 is disposed so as to adjoin the processing block S2 on the side of a direction in which positive values are measured on the X-axis shown in FIGS. 1 and 2. The processing unit S2 is interposed between the cassette station S1 and the carrying unit S3. The carrying unit S3 has a transfer device 33. The transfer device 33 transfers a wafer W between the processing unit S2 and an interface system 30 (300) in a preferred embodiment according to the present disclosure. The transfer device 33 has a support part for supporting a wafer W by a peripheral part of the back surface of the wafer W and carrying the wafer. The support part can move in a direction along the Y-axis shown in FIG. 2 and can turn about the center of a base end thereof. Thus, a wafer W can be transferred between the processing block S2 and the interface system 30.

Referring to FIGS. 1 and 2, the interface system 30 (or 300) of the present disclosure adjoins the carrying unit S3 of the coating and developing system 20. An EUV exposure system 40 adjoins the interface system 30. The interface system 30 is interposed between the coating and developing system 20 and the EUV exposure system 40.

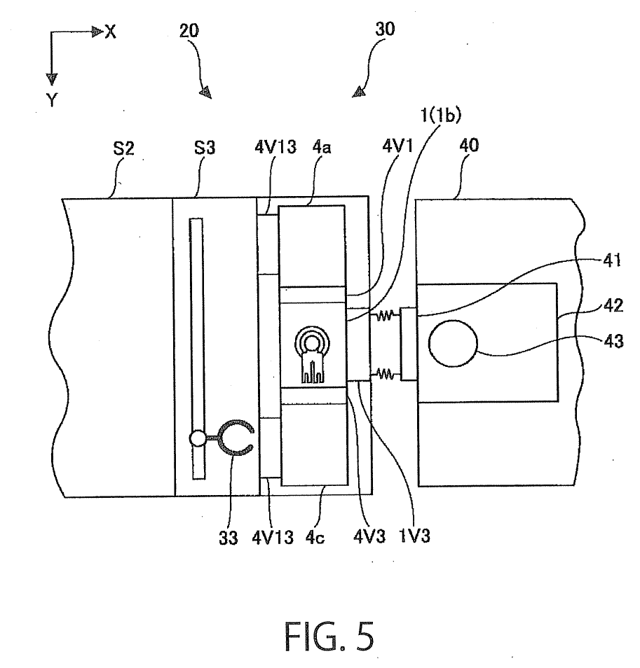

As shown in FIG. 5, the EUV exposure system 40 has a vacuum chamber 42 having a transfer opening, not shown, provided with a gate valve 41, and a wafer stage 43 disposed in the vacuum chamber 42 to support a wafer to be subjected to an exposure process. An optical system, not shown, including a multilayer film mirror is disposed in the vacuum chamber 42. A wafer placed on the wafer stage 43 is exposed to EUV light emitted by an EUV light source disposed outside the vacuum chamber 42.

### First Embodiment

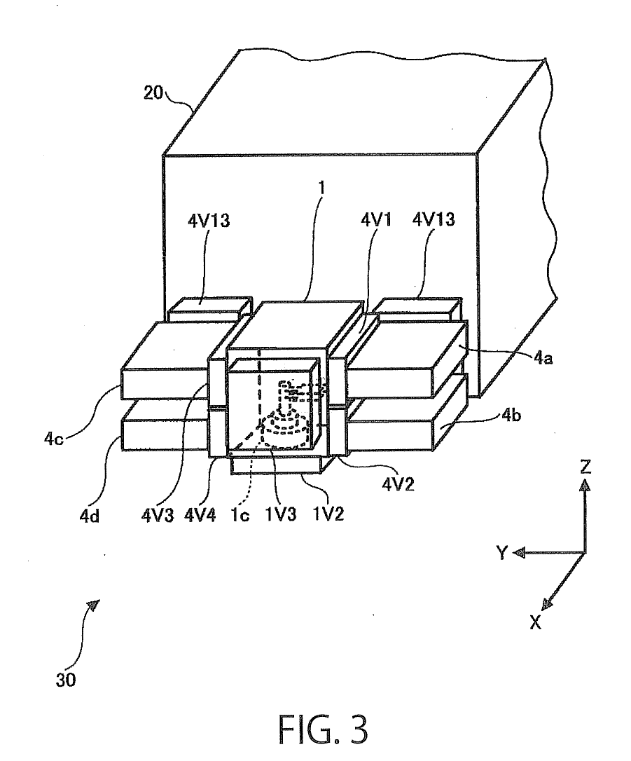

The interface system 30 in a first embodiment according to the present disclosure will be described. FIG. 3 is a perspective view of the interface system 30 taken from the side of the EUV exposure system 40 omitted in FIG. 3.

As shown in FIG. 3, the interface system 30 has a transfer chamber 1 in its substantially central part thereof. The interface system 30 has a load-lock chamber 4a connected to the transfer chamber 1 through a gate valve 4V1, a load-lock chamber 4b disposed under the load-lock chamber 4a and connected to the transfer chamber 1 through a gate valve 4V2, a load-lock chamber 4c connected to the transfer chamber 1 through a gate valve 4V3 and disposed opposite to the load-lock chamber 4a with respect to the transfer chamber 1, and a load-lock chamber 4d connected to the transfer chamber 1 through a gate valve 4V4 and disposed under the load-lock chamber 4c.

The transfer chamber 1 is connected to a turbo-molecular pump, not shown, through a gate valve 1V2. The transfer chamber 1 has a transfer opening, not shown, opening into the EUV exposure system 40, opened and closed by a gate valve 1V3. A wafer W is transferred through this transfer opening between the interface system 30 and the EUV exposure system 40. When the gate valves 1V2 and 1V2 and the gate valves 4V1 to 4V4 are closed, the transfer chamber 1 is sealed. The transfer chamber 1 can be evacuated and maintained in a vacuum of a pressure in the range of 10⁻⁴ to 10⁻⁵ Pa by opening the gate valve 1V2 and operating the turbo-molecular pump. The pressure in the transfer chamber 1 can be measured by a vacuum gage, not shown. The vacuum gage may be an ordinary ion gage. Since it is possible that the properties of a resist film formed on a wafer W are changed by light or electrons emitted by the ion gage, the ion gage shall be disposed so that light and electrons emitted by the ion gage may not reach the resist film. Vacuum gages may be connected to the load-lock chambers 4a to 4d. If the vacuum gages are ion gages, the ion gages shall be disposed so that light and electrons emitted by the ion gages may not reach a resist film.

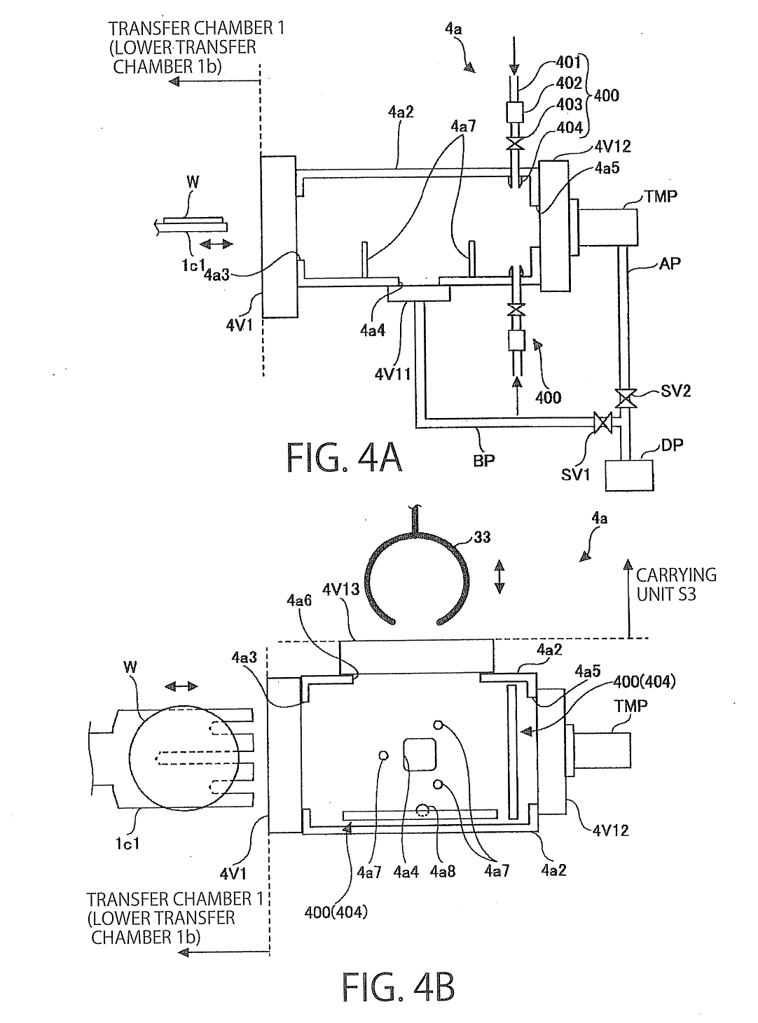

A wafer carrying unit 1c is installed in the transfer chamber 1. The wafer carrying unit 1c is expandable and contractible in vertical directions and is turnable through 360° about a vertical axis. The wafer carrying unit 1c is provided at its end part with two wafer support plates 1c1 for supporting a wafer W thereon. Only one of the wafer support plates 1c1 is shown in FIG. 4. The wafer support plates 1c1 can be moved in the X- and the Y-direction. The two wafer support plates 1c1 can be alternately advanced and retracted to handle two wafers W simultaneously. More concretely, in a state where one of the wafer support plate 1c1 is supporting a wafer W1 and the other wafer support plate 1c1 not supporting any wafer is located in front of, for example, the load-lock chamber 4a, the gate valve 4V1 is opened, the other wafer support plate 1c1 can carry a wafer W2 out from the load-lock chamber 4a, and the former wafer support plate 1c1 can carry the wafer W1 into the load-lock chamber 4a.

The wafer support plates 1c1 may have a cooling function or a heating function, which will be described later.

The load-lock chamber 4a will be described with reference to FIGS. 4(A) and 4(B). FIGS. 4(A) and 4(B) are a schematic sectional view and a schematic top view, respectively, of the load-lock chamber 4a. As shown in FIGS. 4(A) and 4(B), the load-lock chamber 4a has a flat casing 4a2. As shown in FIG. 4(A), the casing 4a2 has a transfer opening 4a3 closable by the gate valve 4V1, an exhaust opening 4a4 closable by a gate valve 4V11, and a high-vacuum exhaust opening 4a5 closable by a gate valve 4V12. As shown in FIG. 4(B), the casing 4a2 has a transfer opening 4a6 closable by a gate valve 4V13.

The transfer opening 4a3 is formed in a side wall of the casing 4a2 facing the carrying chamber 1. The wafer support plate 1c1 transfers a wafer W between the carrying chamber 1 and the casing 4a2.

The transfer opening 4a6 is formed in a side wall of the casing 4a2 facing the coating and developing system 20. The transfer device 33 of the carrying unit S3 of the coating and developing system 30 transfers a wafer W through the transfer opening 4a6 between the coating and developing system 20 and the casing 4a2.

The exhaust opening 4a4 is used for the rough evacuation of the casing 4a2. A bypass pipe BP has one end connected to the gate valve 4V11 closing the exhaust opening 4a4 and the other end connected to a dry pump DR A stop valve SV1 is placed in the bypass pipe BP. The load-lock chamber 4a can be roughly evacuated by this arrangement.

The high-vacuum exhaust opening 4a5 is used for evacuating the casing 4a2 in a high vacuum. A turbo-molecular pump TMP is connected to the gate valve 4aV12 closing the high-vacuum exhaust opening 4a5. An auxiliary exhaust pipe AP has one end connected to the turbo-molecular pump TMP and the other end connected to the dry pump DR A stop valve SV2 is placed in the auxiliary exhaust pipe AP. The load-lock chamber 4a can be evacuated to a high vacuum in the range of, for example, 10⁻⁴ to 10⁻⁵ Pa by this arrangement. The dry pump DP is used as a rough exhaust pump for roughly evacuating the load-lock chamber 4a or an auxiliary pump for the turbo-molecular pump TMP by opening and closing the stop valves SV1 and SV2.

Three wafer support pins 4a7 for supporting a wafer W thereon are placed in the load-lock chamber 4a. the wafer support pins 4a7 of this embodiment do not move vertically. Therefore, the wafer support plate 1c1 and the transfer device 33 are moved vertically to put a wafer W on and to take up a wafer W from the wafer support pins 4a7. In a modification, the wafer support pin 4a7 may be vertically movable.

The casing 4a2 is provided with a set of gas blowers 400. One of the gas blowers 400 is placed in the casing 4a2 at a position remote from the transfer opening 4a3 on the top wall of the casing 4a2 as shown in FIG. 4(A). The other gas bowers 400 is placed in the casing 4a2 at a position remote from the transfer opening 4a6 on the top and the bottom wall of the casing 4a2 as partly shown in FIG. 4(B). Referring to FIG. 4(A), the gas blower 400 includes a pipe 401 closely inserted into a through hole formed in the top wall of the casing 4a2, a gas line filter 402 placed in the pipe 401, and a valve 403 placed at a position nearer to the casing 4a2 than the gas line filter 402 in the pipe 401, and has a gas jetting slit 404 formed in one end part of the pipe 401. The other end of the pipe 401 is connected to a gas source, not shown. The gas source is, for example, a nitrogen gas cylinder (N₂ cylinder). Thus, the gas source can supply N₂ into the pipe 401. The gas source may be a dry air source capable of supplying dry air into the pipe 401. The gas line filter 402 is provided with a filtering film of, for example, a fluoroplastic resin for removing foreign matters contained in N₂ flowing through the pipe 401. As shown in FIG. 4(B), the slit 404 extends in a direction perpendicular to directions in which a wafer W is carried into and carried out from the casing 4a2. Nitrogen gas can be jetted through the slit 404 by this arrangement. The width of the gas jetting slit 404 is determined such that the pressure difference between the pressure of the a gas in the pipe 401 and the pressure of the gas as it leaves the slit 404 is large enough for the gas to form, for example, an air curtain.

As shown in FIG. 4(B), a gas inlet 4a8 is formed in the bottom wall of the casing 4a2. A line provided with a stop valve and a safety valve for preventing pressuring the interior of the casing 4a2, which are not shown in FIG. 4(B), is connected to the gas inlet 4a8. When the stop valve is opened, N₂ or dry air flows into the casing 4a2. Thus, the space in the casing 4a2 can be set at atmospheric pressure. Preferably, N₂ is supplied continuously through the gas inlet 4a8 after the pressure in the casing 4a2 has reached atmospheric pressure. Airflow from the coating and developing system 20 into the casing 4a2 can be suppressed because N₂ flows from the casing 4a2 through the transport opening 4a6 into the coating and developing system 20. If air in the coating and developing system 10 flows into the casing 4a2, water contained in the air adheres to the inside surface of the casing 4a2 and it takes a long time to evacuate the casing 4a2 to a high vacuum. Nitrogen gas supplied through the gas inlet 4a8 suppresses The load-lock chamber 4a of this embodiment can suppress airflow from the coating and developing system 20 into the casing 4a2. Therefore, time necessary for evacuation to a high vacuum can be shortened.

Although the load-lock chamber 4a has been described, the load-lock chambers 4b to 4d are the same in construction as the load-lock chamber 4a. The load-lock chambers 4a to 4d are provided individually with a turbo-molecular pump TMP. The dry pump DP may be shared with all the load-lock chambers 4a to 4d for use as an auxiliary pump or a rough-evacuation pump. When the rough evacuation of the load-lock chamber 4b at atmospheric pressure is desired while the load-lock chamber 4a is under high-vacuum evacuation, the pressure in the by-pass pipe BP and the auxiliary exhaust pipe AP increases temporarily, the turbo-molecular pump TMP does not permit increase of the pressure in the load-lock chamber 4a and maintains the load-lock chamber 4a at a high vacuum.

Referring again to FIG. 2, the interface system 30 includes a control unit 30a for controlling the load-lock chambers, the modules, the gate valves, the pump and various devices included in the interface system 30, a storage device 30b connected to the control unit 30a and storing predetermined programs, an input/output unit (I/O unit) 30c for transferring a program stored in a computer-readable storage medium 30e to the program storage device 30b, and a display unit 30d connected to the control unit 30a to display a process recipe for changing and updating process parameters and the condition of processes.

The control unit 30a may be, for example, a computer including a CPU (central processing unit). The control unit 30a makes the components of the interface system 30 operate in accordance with a program including instructions for the CPU to execute to make the interface system 30 carry out, for example, processes, which will be described later. The programs may be stored in the computer-readable storage device 30e, such as a hard disk, an optical disk, a magnetic disk, a semiconductor storage deice or the like. The I/O unit 30c reads the program from the computer-readable storage device 30e and writes the same to the storage device 30b. When necessary, the control unit 30a reads the program and executes the same. The control unit 30a is connected to a controller, not shown, for controlling the coating and developing system 20 and the EUV exposure system 40. The control unit 30a exchange signals with the controller of the coating and developing system 20 and the EUV exposure system 40 as indicated by the arrows indicated by dotted lines in FIG. 2, to make the coating and developing system 20, the interface system 30 and the EUV exposure system 40 carry out processes. For example, the transfer device 33 of the coating and developing system 30 and the load-lock chamber 4a of the interface system 30 operate synchronously to transfer a wafer W from the transfer device 33 to the load-lock chamber 4a.

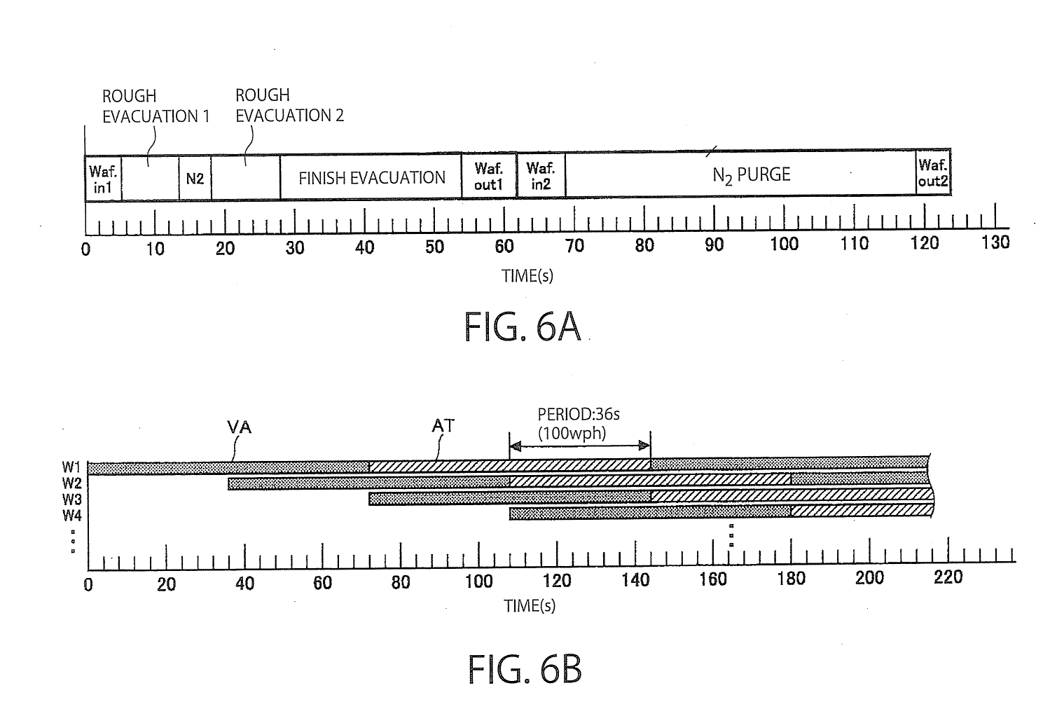

A series of coating, exposure and developing processes to be carried out by the coating and developing system 20, the interface system 30 and the EUV exposure system 40 will be described with reference to FIGS. 2, 5 and 6. FIGS. 6(A) and 6(B) show time charts of assistance in explaining a wafer carrying operation by way of example and are not restrictive.

Resist Film Formation A wafer cassette C containing wafers W is placed on the table 21. Then, the lid of the wafer cassette C is removed, the closable opening 22 corresponding to the wafer cassette C is opened, and the carrying mechanism 23 (FIG. 2) takes out a wafer W from the wafer cassette C.

Subsequently, the wafer W is transferred through the transfer unit, not shown, included in the shelf unit U1 to the main carrying unit 25A. The main carrying unit 25A carries the wafer W to either of the shelf units U1 and U2 to subject the wafer W to pretreatment processes, such as a hydrophobic property imparting process and a cooling process. Then, the wafer W is carried to the coating unit COT to coat the wafer W with a resist film by a spin coater.

Subsequently, the wafer W is carried to the heating unit of one of the shelf units U1 to U3 and is subjected to a prebaking process.

Transfer of the Wafer to the Load-Lock Chamber

Then, the wafer W is transferred from the shelf unit U3 to the transfer device 33 (FIG. 5) of the carrying unit S3. The transfer device 33 supporting the wafer W moves to a position in front of the gate valve 4V13 of the load-lock chamber 4a. At this stage, the load-lock chamber 4a is filled up with N₂ of atmospheric pressure supplied through the gas inlet 4a8 into the load-lock chamber 4a and the gate valve 4V13 is ready to be opened. The gate valve 4V13 is opened and the transfer device 33 advances into the casing 4a2 of the load-lock chamber 4a. Nitrogen gas is supplied continuously through the gas inlet 4a8 into the casing 4a2 while the gate valve 4V13 is opened to suppress the flow of air from the carrying unit S3 into the casing 4a2. Airflow into the casing 4a2 can be still more effectively suppressed by jetting N₂ or dry air through the gas jetting slits 404 of the gas blowers 400. The transfer device 33 moves down in the casing 4a2 to support the wafer W on the support pins 4a7. After the transfer device 33 has been moved out of the casing 4a2, the gate valve 4V13 is closed to complete carrying the wafer W into the load-lock chamber 4a.

Time required to carry the wafer W into the load-lock chamber 4a, namely, a time interval between opening the gate valve 4V13 and closing the gate valve 4V13, is, for 15, example, about 6 s (“waf. in1” in FIG. 6).

Evacuation of Load-Lock Chamber

Then, the gate valve 4V11 is opened and the rough evacuation of the casing 4a2 is done. Duration of rough evacuation is, for example, 9 s (“Rough evacuation 1” in FIG. 6). Evacuation is stopped by closing the gate valve 4V11. Nitrogen gas is supplied through the gas inlet 4a8 for about 4 s (“N₂” in FIG. 6) to increase the pressure in the casing 4a2 to atmospheric pressure. Supply of N₂ through the gas inlet 4a8 is stopped and then, the gate valve 4V11 is opened to repeat rough evacuation again. Duration of this rough evacuation is about 9 s (“Rough evacuation 2” in FIG. 6).

Subsequently, the gate valve 4V11 is closed to stop rough evacuation and, at the same time, the gate valve 4V12 is opened and the turbo-molecular pump TMP is operated for the high-vacuum evacuation of the casing 4a2. The duration of high-vacuum evacuation may be about 26 s (Finish evacuation” in FIG. 6). Even if some air flows into the casing 4a2 of the load-lock chamber 4a when the wafer W is carried into the casing 4a2, the air can be purged by the two cycles of rough evacuation and finish evacuation.

Transfer of the Wafer to the EUV Exposure System

While the load-lock chamber 4a is being evacuated to a high vacuum, the gate valve 1V2 is opened and the turbo-molecular pump, not shown, is opened to evacuate the transfer chamber 1 in a high vacuum.

After the load-lock chamber 4a and the transfer chamber 1 have been evacuated to a high vacuum, the gate valve 4V12 of the load-lock chamber 4a and the gate valve 1V2 of the transfer chamber 1 are closed and the gate valve 4V1 interposed between the load-lock chamber 4a and the transfer chamber 1 is opened. Subsequently, the wafer support plate 1c1 of the wafer carrying unit is placed in the transfer chamber 1 advances into the load-lock chamber 4a, lifts up the wafer W supported on the support pins 7 and carries the wafer W into the transfer chamber 1.

Then, the gate valve 1V3 of the transfer chamber 1 and the gate valve 41 (FIG. 5) of the EUV exposure system 40 are opened and the wafer carrying unit is carries the wafer W into the vacuum chamber 42 of the EUV exposure system 40 and places the wafer W on the wafer stage 43.

Carrying Wafer to Interface System

After the completion of exposure of the wafer W (resist film) on the wafer stage 43 by the EUV exposure system, the gate valves 41 and the 1V3 are opened, the wafer carrying unit is of the interface system 30 carries the wafer W from the wafer stage 43 of the EUV exposure system 40 into the transfer chamber 1 of the interface system 30. Then, the gate valves 41 and 1V3 are closed to complete a carrying operation for carrying the wafer W into the transfer chamber 1. Time necessary for completing the carrying operation may be, for example, about 8 s (“waf. out1” in FIG. 6(A)).

Carrying the Wafer to the Coating and Developing System

Then, the wafer W is carried in accordance with a predetermined carrying flow specifying sequential carrying operations for carrying the wafer W to the predetermined load-lock chamber. More concretely, the wafer W is carried to the load-lock chamber which has been evacuated in a high vacuum by this time in accordance with the carrying flow. Suppose that the wafer W is carried to the load-lock chamber 4a for convenience. Then, the gate valve 4V1 is opened first. The wafer carrying unit 1c carries the exposed wafer W into the load-lock chamber 4a and places the wafer W on the wafer support pins 4a7. After the wafer carrying unit 1c (the wafer support plate 1c1) has been withdrawn from the load-lock chamber 4a, the gate valve 4V1 is closed. Time between the opening and the closing of the gate valve 4V1 is, for example, about 7 s (“waf. in2” in FIG. 6).

Subsequently, the interior of the load-lock chamber 4a is set at atmospheric pressure by supplying, for example, N₂ through the gas inlet 4a8 into the load-lock chamber 4a in, for example, about 50 s (“N₂ purge” in FIG. 6). The gate valve 4V13 is opened while N₂ is continuously supplied through the gas inlet 4a8. Thus, the load-lock chamber 4a communicates with the carrying unit S3 of the coating and developing system 20 by means of the transfer opening 4a6 (FIG. 4(B)). Nitrogen gas flowing from the load-lock chamber 4a toward the carrying unit S3 suppress airflow into the load-lock chamber 4a to maintain the interior of the load-lock chamber 4a in a clean atmosphere.

The transfer device 33 of the carrying unit S3 advances into the load-lock chamber 4a, receives the wafer W from the wafer support pins 4a7 and returns into the carrying unit S3.

Then, the gate valve 4V13 is closed to complete an operation fro carrying the wafer W into the coating and developing system 20. Time necessary for carrying the wafer W from the load-lock chamber 4a to the carrying unit S3 may be, for example, about 5s (“waf. out2” in FIG. 6).

After the wafer W has been carried from the load-lock chamber 4a into the carrying unit S3, the gate valve 4V13 may be closed after the next wafer W has been carried into the load-lock chamber 4a.

Then, the main carrying unit 25B (FIG. 2) carries the exposed wafer W into the developing unit DEV. The developing unit DEV develops the resist film formed on the wafer W to form a resist mask. Then, the main carrying unit 5, 25A and the carrying mechanism 23 (FIG. 2) operate to return the wafer W to the wafer cassette C placed on the table 21.

A carrying procedure for carrying one wafer has been described. Suppose that wafers W1, W2, W3, W4, . . . are to be processed successively. In a state where the wafer W1, for instance, is held in the load-lock chamber 4a and the load-lock chamber 4a is evacuated in a high vacuum, a carrying operation for carrying the next wafer W2 into the load-lock chamber 4b may be started. In a state where the wafer W2 is held in the load-lock chamber 4b and the load-lock chamber 4b is evacuated in a high vacuum, a carrying operation for carrying the next wafer W3 into the load-lock chamber 4c may be started.

When the wafers W are carried in the foregoing carrying mode and the wafer W1 processed by the EUV exposure process is transferred from the transfer chamber 1 to the load-lock chamber 4a, the exposed wafer W is carried to the load-lock chamber holding a wafer W to be carried to the EUV exposure system 40 and completely evacuated to a high vacuum, namely, the load-lock chamber which has completed preparations for carrying a wafer W to the EUV exposure system 40, among the load-lock chambers 4a to 4d. More concretely, the wafer support plate 1c1 not supporting any wafer among the two wafer support plates 1c1 of the wafer carrying unit is advances into the load-lock chamber 4a after the gate valve 4V1 has been opened, takes up the wafer W held in the load-lock chamber 4a and returns into the transfer chamber 1 to carry the wafer W from the load-lock chamber 4a into the transfer chamber 1 (“waf. in1” in FIG. 6(A)). Subsequently, the wafer support plate 1c1 of the wafer carrying unit 1c carries the wafer W carried out from the EUV exposure system 40 into the load-lock chamber 4a and places the wafer W on the wafer support pins 4a7 in the load-lock chamber 4a. Thus, the exposed wafer W is carried into the load-lock chamber 4a (“waf. in2” in FIG. 6(A)). The gate valve 4V1 is closed after the wafer support plate 1c1 has been withdrawn from the load-lock chamber 4a. Time between opening and closing of the gate valve 4V1 may be, for example, 15 s (“waf. in1” +“waf. in2” in FIG. 6(A)).

It is possible to transfer a wafer W not only between the transfer chamber 1 and the load-lock chambers 4a to 4d, but also between the transfer chamber 1 and the vacuum chamber 42 of the EUV exposure system 40.

Throughput can be improved by successively carrying wafers W at time intervals. As mentioned above, time for which one wafer W stays in the interface system 30 is about 124 s as indicated in the time chart shown in FIG. 6(A). Wafers W can be successively carried at the predetermined time interval not at the time interval of 124 s.

A carrying operation for carrying about 100 wafers W in, for example, one hour can be achieved by starting carrying a wafer W at intervals of about 36 s as shown in FIG. 6(B). When wafers W are carried in such a mode, about 144 s can be spared to processing one wafer W by the exposure process. Thus, for example, rough evacuation can be repeated three times or time for high-vacuum evacuation (finish evacuation) can be extended, and entrance of organic substances contained in air into the EUV exposure system 40 can be prevented. In FIG. 6(B), a period in which the pressure in the load-lock chambers 4a to 4d is equal to atmospheric pressure (the sum of times designated by “N₂ purge”, “waf. out2” and “waf.in1” shown in FIG. 6(A)) is designated by “AT” and a period in which the load-lock chambers 4a to 4d are depressurized (an atmosphere in the load-lock chambers 4a to 4d containing N₂ after “rough evacuation 1”) is designated by “VA”.

As mentioned above, the interface system 30 in the first embodiment of the present disclosure is provided with the plurality of load-lock chambers 4a to 4d and can successively transfer wafers one at a time. Therefore, contamination caused by organic substances contained in air can be reduced and throughput can be improved by performing the rough evacuation of the load-lock chambers 4a to 4d, filling up the load-lock chambers 4a to 4d with the cleaning gas at atmospheric pressure, performing rough evacuation again and performing high-vacuum evacuation. Time from coating to exposure and time from exposure to develop for each wafer W is substantially equal. Therefore, the variation of the repeatability of the processes for wafers can be limited to the least extent.

Airflow from the coating and developing system 20 into the load-lock chamber 4a can be prevented by supplying, for example, N₂ through the gas inlet 4a8 into the load-lock chamber 4a. Since N₂ or dry air blown by the gas blowers 400 obstructs the inflow of air, the flow of organic substances contained in air into the load-lock chamber 4a and the EUV exposure system 40 can be prevented, and hence the contamination of the optical system and such of the EUV exposure system 40 is prevented.

The load-lock chambers 4a to 4d are the same in construction and are formed in modules. Therefore, when the gate valve 4V1 and the stop valves SV1 and SV2 of, for example, the load-lock chamber 4a are closed, the casing 4a2 of the load-lock chamber 4a can be separated from the gate valve 4V1 for the maintenance of the load-lock chamber 4a while the load-lock chambers 4b to 4d are in use for carrying out the processes.

### Second Embodiment

An interface system in a second embodiment according to the present disclosure will be described. The interface system in the second embodiment, similarly to the interface system 30 in the first embodiment, is interposed between the coating and developing system 20 and the EUV exposure system 40.

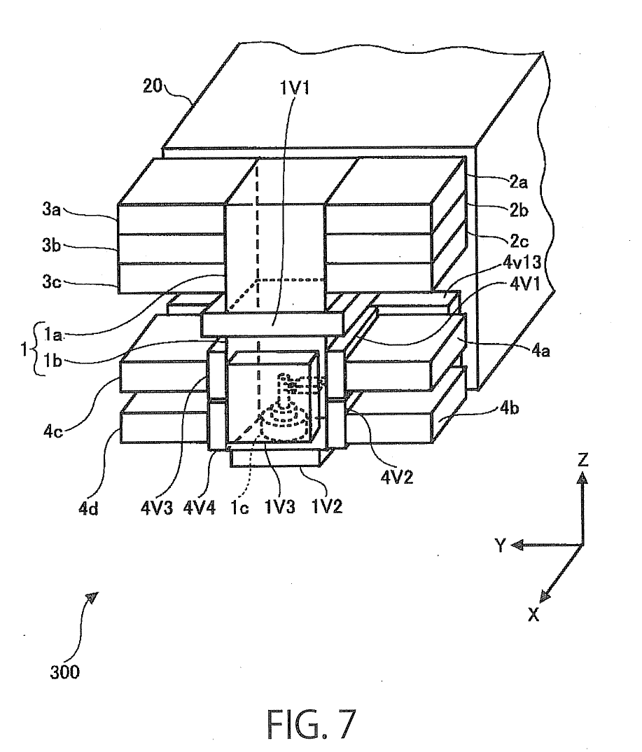

It is known from FIG. 7 that the interface system 300 in the second embodiment differs from the interface system 30 in the first embodiment in that a transfer chamber 1 is divided into an upper transfer chamber is and a lower transfer chamber 1b by a gate valve 1V1 disposed in a substantially middle part of the transfer chamber 1 with respect to a vertical direction, a plurality of load-lock chambers 4a to 4d are connected to the lower transfer chamber 1b by gate valves 4V1 to 4V4, respectively, and heating modules 2a to 2c and cooling modules 3a to 3c are connected to the upper transfer chamber 1a. The interface system 300 is the same in other respects as the interface system 30.

Duplicate description of the load-lock chambers 4a to 4d will be omitted and parts of the interface system 300 in the second embodiment different from those of the interface system 30 in the first embodiment will be mainly described.

Referring to FIG. 7, the interface system 300 has the vertically elongate transfer chamber 1 in its central part. The transfer chamber 1 is divided into the upper transfer chamber is and the lower transfer chamber 1b by the gate valve 1V1 disposed in a substantially middle part of the transfer chamber 1 with respect to a vertical direction. The interface system 300 includes the three heating modules 2a, 2b and 2c stacked up in layers above the load-lock chamber 4a on the right side (the −Y-axis side) of the upper transfer chamber is and communicating with the upper transfer chamber 1a, and the three cooling modules 3a, 3b and 3c stacked up in layers above the load-lock chamber 4c on the left side (the +Y-axis side) of the upper transfer chamber is and communicating with the upper transfer chamber 1a.

When the gate valve 1V1 is closed, the upper transfer chamber is can be evacuated by, for example, a dry pump or the line, not shown and can be maintained in a vacuum in the range of 10⁻² to 10⁻⁴ Pa.

A line, not shown, connecting the upper transfer chamber is and the dry pump is provided with a stop valve, a check valve and a pressure regulating valve. Pressure in the upper transfer chamber 1a can be measured with a vacuum gage, not shown. The vacuum gage may be an ordinary ion gage. Since it is possible that the properties of a resist film formed on a wafer W are changed by light and electrons emitted by the ion gage, the ion gage shall be disposed so that light and electrons emitted by the ion gage may not reach the resist film. Vacuum gages may be connected to the load-lock chambers 4a to 4d, the lower transfer chamber 1b, the heating modules 2a, 2b and 2c and the cooling modules 3a, 3b and 3c, respectively. If the vacuum gages are ion gages, the ion gages shall be disposed so that light and electrons emitted by the ion gages may not reach a resist film.

Connected through the gate valve 1V2 to the lower transfer chamber 1b is, for example, a turbo-molecular pump, not shown. The lower transfer chamber 1b is provided with a transfer opening, not shown, opening into the EUV exposure system 40 and closable by a gate valve 1V3. A wafer W is transferred through this transfer opening between the interface system 300 and the EUV exposure system 40. The lower transfer chamber 1b is sealed in an airtight fashion when the gate valves 1V1 to 1V3 and the gate valves 4V1 to 4V4 are closed. The lower transfer chamber 1b is evacuated by opening the gate valve 1V2 and operating the turbo-molecular pump and is maintained in a vacuum of a pressure in the range of 10⁻⁴ to 10⁻⁵ Pa.

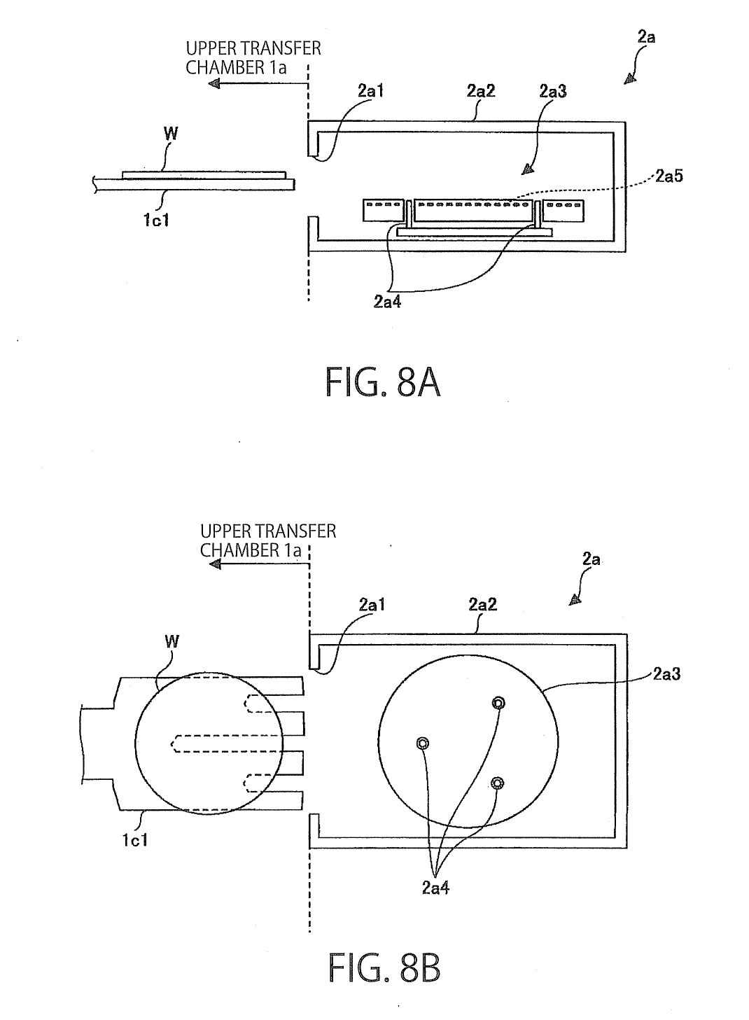

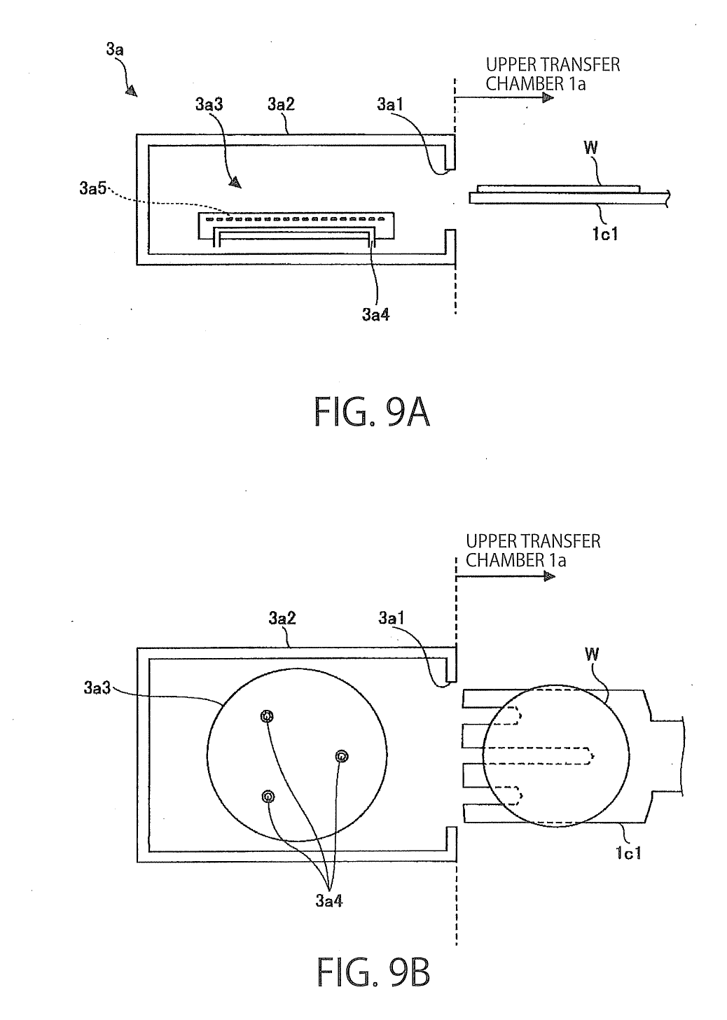

A wafer carrying unit 1c is installed in the transfer chamber 1. The wafer carrying unit 1c is expandable and contractible in vertical directions (a Z-direction in FIG. 7) and is turnable about a vertical axis. The wafer carrying unit 1c is provided at its end part with two wafer support plates 1c1 (only one of the wafer support plates 1c1 is shown in FIGS. 8 and 9) for supporting a wafer W thereon. The wafer support plates 1c1 can be moved in the X- and the Y-direction. The two wafer support plates 1c1 are internally provided with fluid conduits. The temperature of the wafer support plates 1c1 can be regulated by letting a fluid flow through, for example, a flexible tube into the fluid conduits. Thus, the wafer support plates 1c1 can cool wafers W heated by, for example, the heating modules 2a to 2c to some extent (wafer support plates 1c1 can roughly remove heat from the wafers W) before the wafer support plates 1c1 carry the wafers W taken out from the heating modules 3a to 3c to the cooling modules 3a to 3c. Thus, the cooling modules 3a to 3c can quickly and efficiently cool the heated wafers W. The two wafer support plates 1c1 are advanced and retracted alternately to handle two wafers W simultaneously.

The wafer carrying unit is can take out a wafer W from the load-lock chamber and can carry a wafer W into the load-lock chamber 4a (4a to 4d) by advancing the wafer support plate 1c1 into the load-lock chamber 4a (4a to 4d) when the gate valve 4V1 (4V2 to 4V4) is open. The wafer carrying unit is can enter the upper transfer chamber is by extending in the Z-direction when the gate valve 1V1 is open and can advance the wafer support plate 1c1 from the upper transfer chamber is into the heating modules 2a to 2c or the cooling modules 3a to 3c. Thus, the wafer carrying unit is can access not only the load-lock chambers 4a to 4d, but also to the heating modules 2a to 2c and the cooling modules 3a to 3c.

Referring to FIGS. 8(A) and 8(B), the heating module 2a includes a flat casing 2a2 provided with an opening 2a1 opening into the upper transfer chamber 1a, and a stage 2a3 disposed in the casing 2a2 to support thereon a wafer W carried from the upper transfer chamber 1a into the casing 2a2 by the wafer carrying unit is (the wafer support plate 1c1). The stage 2a3 is internally provided with an electric heater and a thermocouple, which are not shown. The stage 2a3 is maintained at a predetermined temperature by the electric heater, the thermocouple and a predetermined temperature regulator. Thus, a wafer W placed on the stage 2a3 can be heated. Three lifting pins 1a4 can move up and down in through holes formed in the stage 2a3. The lifting pins 1a4 can receive a wafer W supported above the stage 2a3 by the wafer support plate 1c1 from the wafer support plate 1c1 and can place the wafer W on the stage 2a3. The lifting pins 1a4 can lift up a wafer placed on the stage 2a3 and can transfer the wafer W to the wafer support plate 1c1.

As shown in FIG. 8(A), the stage 2a3 is provided with an electrostatic chuck 1a5. When a pour source, not shown, applies a predetermined voltage to the electrostatic chuck, a wafer placed on the stage 2a3 is held in close contact with the stage 2a3 by electrostatic force. Consequently, the wafer W can be efficiently heated. The interior of the heating module 2a connecting through the opening 2a1 to the upper transfer chamber 1a is maintained at a reduced pressure. Therefore, heat is transferred scarcely by convection, and hence the effect of holding a wafer W in close contact with the stage 2a3 by the electrostatic chuck 1a5 is important.

The heating modules 2b and 2c are the same in construction as the heating module 2a.

Referring to FIGS. 9(A) and 9(B), The cooling module 3a includes a flat casing 3a2 provided with an opening 3a1 opening into the upper transfer chamber 1a, and a stage 3a3 disposed in the casing 3a2 to support thereon a wafer W carried from the upper transfer chamber 1a into the casing 3a2 by the wafer carrying unit 1c. As shown in FIG. 9(A), the stage 3a3 is internally provided with a conduit 3a4. A predetermined temperature-regulated fluid is circulated through the conduit 3a4 by a fluid circulator, not shown, having a temperature regulating function to maintain the stage 3a3 at a predetermined temperature. Thus, a wafer W placed on the stage 3a3 can be cooled. As shown in FIG. 9(B), the stage 3a3, similarly to the stage 2a3 of the heating module 2a, is provided with three lifting pins 3a4 capable of projecting from and sinking beneath the upper surface of the stage 3a3 to lift up a wafer W. The stage 3a3 is provided with an electrostatic chuck 3a5 as shown in FIG. 9(A). The electrostatic chuck 3a5 holds a wafer W placed on the stage 3a3 by the lifting pins 3a4 in close contact with the upper surface of the stage 3a3. Thus, heat transfer from the wafer W to the stage 3a3 is promoted.

The cooling modules 3b and 3c are the same in construction as the cooling module 3a.

A series of coating, exposure and developing processes to be carried out by the coating and developing system 20, the interface system 300 and the EUV exposure system 40 will be described.

Resist Film Formation

A wafer cassette C containing wafers W is placed on the table 21. Then, the lid of the wafer cassette C is removed, the closable opening 22 corresponding to the wafer cassette C is opened, and the carrying mechanism 23 (FIG. 2) takes out a wafer W from the wafer cassette C.

Subsequently, the wafer W is transferred through the transfer unit, not shown, included in the shelf unit U1 to the main carrying unit 25A. The main carrying unit 25A carries the wafer W to a shelf of either of the shelf units U1 and U2 to subject the wafer W to pretreatment processes, such as a hydrophobic property imparting process and a cooling process. Then, the wafer W is carried to the coating unit COT to coat the wafer W with a resist film by a spin coater.

Transfer of Wafer to Load-Lock Chamber

Then, the wafer W is transferred from the shelf unit U3 to the transfer device 33 of the carrying unit S3. The transfer device 33 supporting the wafer W moves to a position in front of the gate valve 4V13 of the load-lock chamber 4a (FIG. 5). At this stage, the load-lock chamber 4a is filled up with N₂ of atmospheric pressure supplied through the gas inlet 4a8 into the load-lock chamber 4a and the gate valve 4V13 is ready to be opened. When the gate valve 4V13 is opened, the transfer device 33 advances into the casing 4a2 pf the load-lock chamber 4a. Nitrogen gas is supplied continuously through the gas inlet 4a8 into the casing 4a2 while the gate valve 4V13 is open to suppress airflow from the carrying unit S3 into the casing 4a2. Airflow into the casing 4a2 can be still more effectively suppressed by jetting N₂ or dry air through the gas jetting slits 404 of the gas blowers 400. The transfer device 33 moves down in the casing 4a2 to support the wafer W on the support pins 4a7.

Evacuation of Load-Lock Chamber

The gate valve 4V13 is closed after the transfer device 33 has been retracted from the casing 4a2. then, the gate valve 4V11 is opened and the rough evacuation of the casing 41s is performed. Subsequently, the interior of the casing 4a2 is set at atmospheric pressure by supplying N₂ through the gas inlet 4a8 into the casing 4a2 after closing the gate valve 4V11 and stopping evacuation. Then, the supply of N₂ through the gas inlet 4a8 is stopped, the gate valve 4V11 is opened and rough evacuation is performed again. Thus, a little air that may flow from the carrying unit S3 into the casing 4a2 can be purged. The high-vacuum evacuation of the casing 4a2 may be performed by the turbo-molecular pump TMP after the second cycle of rough evacuation. High-vacuum evacuation can promote the outgassing of the resist film not yet prebaked and shortens prebaking time; that is, throughput can be improved.

Carrying Wafer to Heating Module

The lower transfer chamber 1b is evacuated at a predetermined pressure and the preparation of the lower transfer chamber 1b for receiving the wafer W is completed while the load-lock chamber 4a is in the process of rough evacuation. After the interior of the casing 4a2 of the load-lock chamber 4a has been set at a predetermined pressure, the gate valve 4V1 interposed between the load-lock chamber 4a and the lower transfer chamber 1b is opened and the wafer support plate 1c1 of the wafer carrying unit is placed in the lower transfer chamber 1b advances into the casing 4a2 to receive the wafer W.

The wafer support plate 1c1 supporting the wafer W is returned into the lower transfer chamber 1b, and then the gate valve 4V1 is closed.

During the transfer of the wafer W from the load-lock chamber 4a to the lower transfer chamber 1b, the upper transfer chamber 1a to which the wafer W is to be delivered is set at a predetermined pressure. The gate valve 1V1 (FIG. 7) between the lower transfer chamber 1b and the upper transfer chamber 1ais opened, the wafer carrying unit is extends upward into the upper transfer chamber 1aand carries the wafer W through the opening 2a1 of the heating module 2a into the casing 2a2 of the heating module 2a. The lifting pins 1a4 receive the wafer W and place the same on the stage 2a3. Then, the electrostatic chuck 1a5 holds the wafer W in close contact with the upper surface of the stage 2a3. At this stage, the stage 2a3 is maintained at a predetermined temperature to heat the wafer W coated with the resist film for prebaking. Prebaking temperature may be, for example, in the range of about 80° C. to about 150° C. and prebaking time may be, for example, in the range of about 30 s to about 120 s. Since the interior of the casing 2a2 of the heating module 2a, similarly to that of the upper transfer chamber 1a, is maintained at the predetermined pressure (a negative pressure), the outgassing of the resist film is promoted to reduce outgassing in the vacuum chamber 42 of the EUV exposure system 40 into which the wafer W is to be carried later. Thus, the contamination of the optical system with a solvent and such contained in the resist film can be reduced.

During the foregoing procedure for processing the preceding wafer W, the same procedures for a second and succeeding wafers W are started sequentially. For example, the second wafer is carried from the load-lock chamber 4b through the lower transfer chamber 1b and the upper transfer chamber 1a into the heating module 2b and the second wafer is subjected to prebaking. For example, the third wafer is carried from the load-lock chamber 4c through the lower transfer chamber 1b and the upper transfer chamber 1a into the heating module 2c and the fourth wafer is carried into, for example, the load-lock chamber 4d.

Carrying Wafer to Cooling Module

The wafer carrying unit is carries the wafer W from the heating module 2a to the cooling module 3a after the completion of the prebaking of the wafer W in the heating module 2a (after the passage of a predetermined prebaking time). Since the wafer support plate 1c1 of the wafer carrying unit 1c is cooled, the cooling of the wafer W starts immediate after the wafer support plate 1c1 has received the wafer W. Therefore, the wafer W has been cooled at a lower temperature before the wafer W is placed on the stage 3a3 of the cooling module 3a and hence the cooling module 3a can efficiently cool the wafer W. The cooling module 3a cools the wafer W at a temperature approximately equal to the room temperature (about 22° C.).

The wafers W held in the heating modules 2b and 2c are carried to the cooling modules 3b and 3c, respectively, and wafers W held in the load-lock chambers 4a to 4d are carried sequentially to the heating modules 2a to 2c, respectively.

Carrying Wafer to EUV Exposure System

The wafer carrying unit 1c carries the wafer W cooled in the cooling module 3a through the upper transfer chamber 1a into the lower transfer chamber 1b. After the gate valve 1V1 between the upper transfer chamber 1a and the lower transfer chamber 1b has been closed, the gate valve 1V2 is opened to evacuate the lower transfer chamber 1b in a high vacuum.

After the interior of the lower transfer chamber has been set at a predetermined pressure, the gate valve 1V3 of the lower transfer chamber 1b and the gate valve 41 of the EUV exposure system 40 are opened, and the wafer carrying unit is carries the wafer W into the vacuum chamber 42 of the EUV exposure system 40 and places the same on the wafer stage 43 (FIG. 5).

Carrying Wafer into Interface System

After the completion of the exposure of the wafer W (the resist, film) on the wafer stage 43, the gate valves 41 and 1V3 are opened, and the wafer carrying unit 1c of the interface system 300 carries the wafer W from the wafer stage 43 of the EUV exposure system 40 into the lower transfer chamber 1b of the interface system 300. While the EUV exposure system 40 is performing the exposure process, the second and the following wafers W are carried to and from the heating modules 2a to 2c, the cooling modules 3a to 3c and the load-lock chambers 4a to 4d. Therefore, the gate valve 1V1 between the upper transfer chamber is and the lower transfer chamber 1b is open and the interior of the lower transfer chamber 1b is kept at a pressure that can be achieved by the dry pump. When the wafer is carried out from the EUV exposure system 40, the gate valve 1V1 is closed at a predetermined point of time and the lower transfer chamber 1b is evacuated through the gate valve 1V2 in a high vacuum. Thus, the interior of the vacuum chamber 42 of the EUV exposure system 40 can be maintained in a high vacuum.

Carrying Wafer to Heating Module and Cooling Module

The wafer W returned to the lower transfer chamber 1b is carried in accordance with a predetermined carrying flow to the predetermined heating module (the heating module 2a herein for convenience) for post-exposure baking.

More concretely, the gate valve 1V1 is opened, and the wafer carrying unit extends upward into the upper transfer chamber 1a and carries the wafer W through the opening 2a1 of the heating module 2a into the casing 2a2 of the heating module 2a. The lifting pins 1a4 place the wafer W on the stage 2a3, and then the electrostatic chuck 1a5 holds the wafer W in close contact with the upper surface of the stage 2a3. Thus, the wafer W is subjected to the post-baking process. Then, the wafer carrying unit 1c carries the wafer W from the heating module 2a to some one of the cooling modules 3a to 3c. The cooling module to which the wafer W is to be carried is specified in the predetermined carrying flow. (It is supposed that the wafer W is carried to the cooling module 3a for convenience.) When the wafer W is carried by the wafer carrying plate 1c1, the wafer carrying plate 1c1 cools the wafer W at a lower temperature.

Carrying Wafer to Coating and Developing System

The wafer carrying unit is carries the wafer W cooled at a temperature near the room temperature (about 22° C.) by the cooling module 3a from the cooling module 3a through the upper transfer chamber is to the lower transfer chamber 1b. Then, the wafer W is carried to the predetermined load-lock chamber specified in the carrying flow. (It is supposed that the wafer W is carried to the load-lock chamber 4a for convenience.) First, the gate valve 1V1 is closed, and then the gate valve 4V1 is opened. Then, the wafer carrying unit is carries the wafer W into the load-lock chamber 4a and put the wafer W on the lifting pins 4a7 in the load-lock chamber 4a. After the wafer carrying unit is (the wafer support plate 1c1) has been moved out of the load-lock chamber 4a, the gate valve 4V1 is closed, N₂ is supplied through the gas inlet 4a8 into the load-lock chamber 4a to set the interior of the load-lock chamber 4a at atmospheric pressure. Then, the gate valve 4V1 is opened while N₂ is being continuously supplied into the load-lock chamber 4a. Consequently, the load-lock chamber 4a communicates with the carrying unit S3 of the coating and developing system 20 by means of the transfer opening 4a6 (FIG. 4(B)). Nitrogen gas that flows from the load-lock chamber 4a into the carrying unit S3 suppresses the inflow of air from the carrying unit S3, and hence a clean atmosphere is maintained in the interior of the load-lock chamber 4a.

The transfer device 33 of the carrying unit S3 advances into the load-lock chamber 4a, receives the wafer W from the lifting pins 4a7 and returns into the carrying unit S3.

Subsequently, the gate valve 4V1 is closed to complete the carrying operation for carrying the wafer W into the coating and developing system 20.

After the completion of the carrying operation, the main carrying unit 25B (FIG. 2) carries the wafer W to the developing unit DEV. The developing unit DEV develops the resist film on the wafer W to form a resist mask. Then, the wafer W is returned into the wafer cassette D placed on the table 21.

The interface system 300 in the second embodiment of the present disclosure has the plurality of heating modules 2a to 2c, the plurality of cooling modules 3a to 3c and the plurality of load-lock chambers 4a to 4d. Therefore wafers W can be carried one by one in accordance with the carrying flow produced on the basis of heating and cooling conditions and hence the reduction of throughput can be avoided. Resist film formation to exposure, and exposure to development fir each wafer W can be completed in the substantially the same time. Therefore, the variation of the repeatability of the processes for wafers can be limited to the least extent.

The load-lock chambers 4a to 4d, similarly to those of the interface system 30 in the first embodiment, are formed in modules of the same construction. Therefore, when the gate valve 4V1 of the load-lock chamber 4a and the stop valves SV1 and SV1 in the lines connected to the load-lock chamber 4a are closed, for instance, the casing 4a of the load-lock chamber 4a can be disconnected from the gate valve 4V1 and the maintenance of the load-lock chamber 4a can be accomplished while the load-lock chambers 4b to 4d are in use for carrying out the processes.

Since wafers are carried to and from the heating modules 2a to 2c, the cooling modules 3a to 3c and the load-lock chambers 4a to 4d under a reduced pressure, the lower transfer chamber 1b can be maintained at a reduced pressure. Therefore, the lower transfer chamber 1b needs to be evacuated not from atmospheric pressure, but from a predetermined reduced pressure to a high vacuum when a wafer

W is to be carried from the lower transfer chamber 1b into the EUV exposure system 40 and hence the wafer W can be transferred from the lower transfer chamber 1b to the EUV exposure system 40 in a short time. Thus, throughput is not uselessly reduced.

Wafers W each coated with a resist film by the coating and developing system 20 are carried through the load-lock chambers 4a to 4d of the interface system 300 into the to the heating modules 2a to 2c evacuated at a reduced pressure and are subjected to the prebaking process in the heating modules 2a to 2c. Therefore, solvent and such contained in the resist film can be made evaporate thoroughly, and hence the contamination of the optical system and such of the EUV exposure system 40 by the outgassing of the resist film can be reduced.

Airflow from the coating and developing system 20 into the load-lock chamber 4a can be prevented by supplying N₂ through the gas inlet 4a8 into the load-lock chamber 4a. Airflow from the coating and developing system 20 into the load-lock chamber 4a can be obstructed by N₂ or dry air jetted into the load-lock chamber 4a by the gas blowers 400. Thus, the flow of organic substances contained in air into the load-lock chamber 4a and the EUV exposure system 40 can be prevented, and hence the contamination of the internal optical system and such of the EUV exposure system can be prevented.

A heating module capable of being maintained at a reduced pressure is necessary for achieving a heating process in a vacuum. However, it is difficult to provide a coating and developing system previously installed in a cleanroom with such a heating module in most cases due to special restriction. Therefore, in some cases, a new coating and developing system provided with a heating module capable of being maintained at a reduced pressure is needed. The interface system 300 of the present disclosure that can be installed between an exposure system and a coating and developing system enables the use of an existing coating and developing system and performing a heating process under a reduced pressure.

Description has been made on an assumption that the postbaking process is performed in a vacuum by the heating modules 2a to 2c by way of example, the postbaking process may be performed by the heating unit included in the coating and developing system 20.

Although the present disclosure has been described in terms of its preferred embodiments, the present disclosure is not limited in its application to those embodiments described herein and various changes may be made therein without departing from the scope of claims.

For example, each of the first and the second embodiments is provided with the set of gas blowers 400, namely, the upper and the lower gas blower 400. The embodiments may be provided with only one of the gas blower. In such a case, it is preferable to dispose the gas blower in each of the load-lock chambers 4a to 4d. near the top wall.

In the first and the second embodiment, each of the gas blowers 400 may be provided with a gas nozzle provided with orifices arranged at predetermined intervals instead of the jetting slit 404.

In the interface system 30 in the first embodiment and the interface system 300 in the second embodiment, the gas jetting slit 404 of, for example, the gas blower 400 may be attached to the gas inlet 4a8 so as to jet N₂ toward the transfer opening 4a6. A gas nozzle provided with a plurality of orifices arranged at predetermined intervals may be disposed with the orifices facing the transfer opening 4a6. Thus, the inflow of air from the coating and developing system 20 can be still more surely reduced. Forming the casing 4a2 in a low height is effective in producing a laminar flow in the casing 4a2. It is preferable that the height of the casing 4a2 is as low as possible, provided that a wafer W does not touch the edges of the transfer openings 4a3 and 4a6 and the jetting slits 40 when the wafer W is carried into and carried out of the casing 4a2. Preferably, the height of the casing 4a2 is in the range of about 3 cm to about 10 cm. If the height of the casing 4a2 is lower than about 3 cm, the conductance to the gas during evacuation is high, and hence it takes a long time to evacuate the casing 4a2. If the height of the casing is higher than about 10 cm, it is difficult to supply N₂ through the gas inlet 4a8 in a laminar flow. More desirably, the height is in the range of about 4 cm to about 6 cm.

In the second embodiment, doors may be used for closing and opening the openings of the heating modules 2a to 2c and the cooling modules 3a to 3c. When doors are used, the effect of the pressure variation in the upper transfer chamber is on the interior of the heating modules 2a to 2c and the cooling modules 3a to 3c can be reduced by closing the doors after wafers W have been carried into the heating modules 2a to 2c and the cooling modules 3a to 3c. Although the doors may be gate valves, the doors may be simple devices such as labyrinthine structures or butterfly valves.

In the first and the second embodiment, high-vacuum pumps, such as oil diffusion pumps, capable of evacuating the load-lock chambers 4a to 4d in a high vacuum of a pressure in the range of 10⁻⁴ to 10⁻⁵ Pa may be used instead of the turbo-molecular pumps TMP.

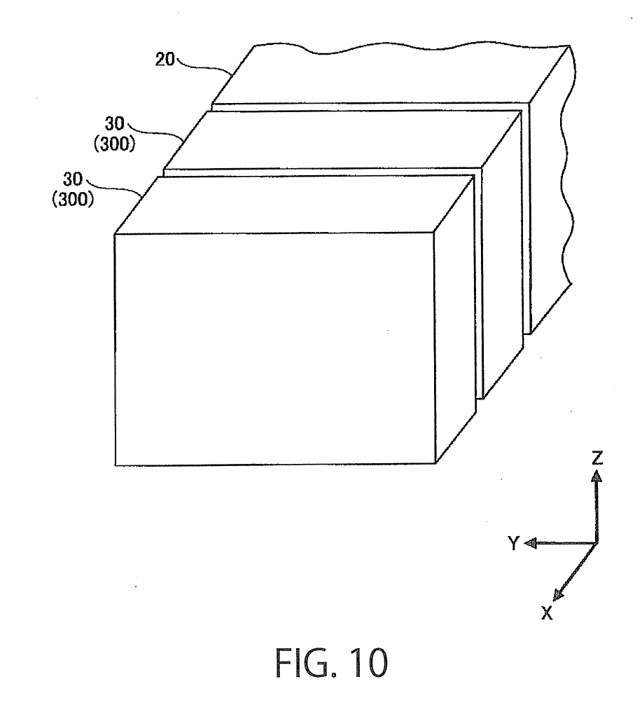

The plurality of interface system 30, the plurality of interface system 300 or a combination of the interface systems 30 and 300 may be interposed between the coating and developing system and the EUV exposure system as shown in FIG. 10. Such an arrangement can transfer wafers W without keeping the wafers W waiting.

The gate valve 1V1 may be kept open when the interface system 300 in the second embodiment is used for carrying out the coating, exposure and developing processes. In this case, it is preferable that the upper transfer chamber 1a, the heating modules 2a to 2c and the cooling modules 3a to 3c are structured such that the interior thereof can be evacuated to a pressure in the range or 10⁻⁴ to 10⁻⁵ Pa. When the upper transfer chamber 1a, the heating modules 2a to 2c and the cooling modules 3a to 3c are thus, structured, a wafer W can be transferred from the lower transfer chamber 1b into the vacuum chamber 42 of the EUV exposure system 40 under a low pressure on the order of 10⁻⁴ Pa lower than that can be achieved by a dry pump or a rotary pump. The pressure of this degree can satisfactorily prevent the contamination of the internal optical system and such of the EUV exposure system 40. If the type of the resist permits the omission of prebaking under a reduced pressure, the gate valve 1V1 of the interface system 300 in the second embodiment is kept open and the arrangement including the interface system 300, similarly to the arrangement including the interface system 30 in the first embodiment, can carryout the coating, exposure and developing processes. The gate valve 1V1 is closed and the maintenance of the heating modules 2a to 2c and the cooling modules 3a to 3c of the interface system 300, similarly to those of the interface system 30 in the first embodiment, can be performed while the coating, exposure and developing processes are in progress.

In the first and the second embodiment, the wafer W may be a semiconductor wafer, such as a silicon wafer or may be a glass plate for forming a flat-panel display (FPD). The interface system 30 (300) of the present disclosure can be used in combination with not only a coating and developing system and an EUV exposure system for fabricating semiconductor devices, but also a coating and developing system and an EUV exposure system for fabricating FPDs.

### REFERENCE CHARACTERS

20 . . . Coating and developing system, 30 . . . Interface system, 40 . . . EUV Exposure system, 1 . . . Transfer chamber, is . . . Wafer carrying unit, 1c1 . . . Wafer support plate, is . . . Upper transfer chamber, 1b . . . Lower transfer chamber, 1V1 to 1V3 . . . Gate valves, 4a to 4d . . . Load-lock chambers, 4V1 to 4V4 . . . Gate valves, 4a7 . . . Lifting pin, 4a8 . . . Gas inlet, 400 . . . Gas blower, TMP Turbo-molecular pump, 2a to 2c . . . Heating modules, 1a4 . . . Lifting pin, 1a5 . . . Electrostatic chuck, 3a to 3c . . . Cooling modules, 3a4 . . . Lifting pin, 3a5 . . . Electrostatic chuck, 42 . . . Vacuum chamber (EUV Exposure system), 43 . . . Wafer stage (EUV Exposure system).

1. An interface system to be interposed between an exposure system using extreme ultraviolet light for exposing a resist film, and a coating and developing system for forming a resist film on a substrate and developing the resist film exposed by the exposure system, said interface system comprising:
a first transfer chamber having a closable first transfer opening through which a substrate is transferred between the first transfer chamber and the exposure system and capable of being evacuated to a reduced pressure; and
a plurality of load-lock chambers capable of being evacuated to a reduced pressure and each having a closable second transfer opening through which a substrate is transferred between the load-lock chamber and the first transfer chamber, and a closable third transfer opening through which a substrate is transferred between the load-lock chamber and the coating and developing system.

2. The interface system according to claim 1 further comprising a second transfer chamber having a closable fourth transfer opening through which a substrate is transferred between the second transfer chamber and the first transfer chamber, and capable of being evacuated at a reduced pressure;
a plurality of heating modules for heating a substrate under a reduced pressure each having a closable fifth transfer opening by means of which the heating module communicates with the second transfer chamber to transfer a substrate; and
a plurality of cooling modules for cooling a substrate under a reduced pressure each having a sixth transfer opening by means of which the cooling module communicates with the second transfer chamber to transfer a substrate.

3. The interface system according to claim 1, wherein each of the load-lock chambers is provided with a gas jetting unit for jetting a gas onto a substrate being carried into or being carried out of the load-lock chamber, disposed near either or both of the second and the third transfer opening.

4. The interface system according to claim 1, wherein each of the load-lock chambers is provided with a gas supply unit for supplying a gas into the load-lock chamber.

5. The interface system according to claim 4, wherein
the gas supply unit is disposed so as to produce a gas flowing toward the third transfer opening when the third transfer opening is open.

6. The interface system according to claim 1, wherein the plurality load-lock chambers are stacked up in layers.

7. The interface system according to claim 1, wherein the first transfer chamber is provided with a substrate carrying unit for carrying a substrate into and carrying a wafer out of the plurality of load-lock chambers.

8. The interface system according to claim 1, wherein the plurality of load-lock chambers are individually provided with a vacuum pump.

9. The interface system according to claim 2, wherein the plurality of heating modules are stacked up in layers.

10. The interface system according to claim 2, wherein the plurality of cooling modules are stacked up in layers.

11. The interface system according to claim 2, wherein the first transfer chamber is provided with a substrate carrying unit for carrying a substrate to and carrying out a substrate from the plurality of load-lock chambers, the plurality of heating modules and the plurality of cooling modules.

12. The interface system according to claim 2, wherein both or either the plurality of heating modules and the plurality of cooling modules are provided with a stage provided with an electrostatic chuck, for supporting a substrate thereon.

13. The interface system according to claim 2, wherein both or either of the fifth and the sixth transfer opening is provided with a closable door.

14. A substrate carrying method for carrying a substrate from a coating and developing system through the interface system according to claim 1 to an exposure system, said substrate carrying method comprising the steps of:
carrying a substrate coated with a resist film from the coating and developing system to one of the plurality of load-lock chambers of the interface system under atmospheric pressure;
evacuating the same load-lock chamber at a reduced pressure;
carrying the substrate from the same load-lock chamber to the first transfer chamber under the reduced pressure; and
carrying the substrate from the first transfer chamber into the exposure system.

15. The substrate carrying method according to claim 14, wherein each of the plurality of load-lock chambers is provided with a gas jetting unit disposed near both or either of the second and the third transfer opening to jet a gas onto a substrate being carried into or being carried out of the load-lock chamber, and the gas jetting unit jets the gas toward the substrate being carried into the load-lock chamber in the step of carrying the substrate into the load-lock chamber.

16. The substrate carrying method according to claim 14, wherein each of the load-lock chambers is provided with a gas supply unit for supplying a gas into the load-lock chamber.

17. A substrate carrying method for carrying a substrate from a coating and developing system through the interface system according to claim 2 to an exposure system, said substrate carrying method comprising the steps of:
carrying a substrate coated with a resist film from the coating and developing system to one of the plurality of load-lock chambers of the interface system under atmospheric pressure;
evacuating the same load-lock chambers in a first vacuum;
carrying the substrate from the same load-lock chamber to the first transfer chamber in the first vacuum;
carrying the substrate from the first transfer chamber through the second transfer chamber to one of the plurality of heating modules in the first vacuum;
heating the substrate in the same heating module in the first vacuum;
carrying the substrate from the same heating module to one of the plurality of cooling modules in the first vacuum;
cooling the substrate in the same cooling module in the first vacuum;
carrying the substrate from the same cooling module through the second transfer chamber to the first transfer chamber in the first vacuum;
evacuating the first transfer chamber in a second vacuum lower than the first vacuum; and
carrying the substrate from the first transfer chamber into the exposure system in the second vacuum.

18. The substrate carrying method according to claim 17, wherein the pressure of the first vacuum is in the range of 10⁻⁴ to 10⁻⁵ Pa and the pressure of the second vacuum is in the range of about 10⁻² to 10⁻⁴ Pa.

19. A substrate carrying method for carrying a substrate from a coating and developing system through the interface system according to claim 1 to an exposure system, said substrate carrying method comprising the steps of
carrying a substrate processed by an exposure process by the exposure system to the first transfer chamber under a reduced pressure;
carrying the substrate from the first transfer chamber to one of the plurality of load-lock chambers under a reduced pressure;
setting the interior of the same load-lock chamber at atmospheric pressure; and
carrying the substrate from the load-lock chamber to the coating and developing system.

20. A computer-readable storage medium storing a computer program specifying the substrate carrying method according to claim 14 to be carried out by the interface system.
